(19) United States
(12) Patent Application Publication
(10) Pub. No.: US 2021/0255003 A1
(43) Pub. Date: Aug. 19, 2021

(54) A MAGNETIC ENCODER

(71) Applicant: AGENCY FOR SCIENCE, TECHNOLOGY, AND RESEARCH, Singapore (SG)

(72) Inventors: Chun Lian ONG, Singapore (SG); Zhimin YUAN, Singapore (SG); Hongtao WANG, Singapore (SG); Budi SANTOSO, Singapore (SG)

(21) Appl. No.: 17/253,428

(22) PCT Filed: Jun. 26, 2019
(86) PCT No.: PCT/SG2019/050318

§ 371 Date: Dec. 17, 2020

(30) Foreign Application Priority Data
Jun. 28, 2018 (SG) 10201805610T

(51) Int. Cl. G01D 5/249; G01D 5/14; G01B 7/30

(52) U.S. Cl. CPC G01D 5/2497; G01B 7/30; G01D 5/145

(57) ABSTRACT

Disclosed is a magnetic encoder for determining a position of a first object relative to a second object. The encoder comprises a first magnetic member, a second magnetic member and a sensor member. The sensor member comprises a first sensor for measuring a change in magnetic field of the first magnetic member for deducing an unsigned absolute position of the first object relative to the second object, and a second sensor for measuring a change in magnetic field of the second magnetic member for deducing a sign for the unsigned absolute position. The first magnetic member and first sensor are coupled to respectively different ones of the first object and second object, and the second magnetic member and second sensor are coupled to respectively different ones of the first object and second object.

### TECHNICAL FIELD

The present invention relates, in general terms, to a magnetic encoder for determining a position of a first object relative to a second object. More particularly, the present invention relates to, but is not limited to, a rotary encoder for determining the angular position of a shaft relative to a fixed member.

### BACKGROUND

Magnetic encoders are devices for determining displacement. In some cases, they determine the angular position of a shaft. In other cases, they determine the distance of linear travel of a device or system component.

There are a number of different types of magnetic encoder. In some arrangements, a magnetic encoder using a Hall effect or magneto-resistive (MR) sensor—e.g. anisotropic MR (AMR), giant MR (GMR) or tunnelling MR (TMR) sensor—a dipole magnet is used to derive the absolute angular position using sine and cosine signals. However, the resolution achievable using such configurations is only 8 to 12 bit resolution.

Another type of magnetic encoder uses a multi-pole pair with an array of Hall sensors to create a differential sine and cosine signal. These are useful in rejecting the common (across all poles) effect of Earth's magnetic field. This type of encoder is typically an incremental encoder. Thus, such encoders can only be used to ascertain how far an object has moved but are not capable of specifying exactly where the object is—e.g. a shaft may have moved 45° from its starting point, but the starting point and thus the current position may be indeterminate.

Although multiple magnetic pole-pairs have been produced to facilitate higher resolution outputs, the typical configurations have space-constraints that limit the scalability of increasing the number of pole-pairs for higher resolution—e.g. Hall sensors are of a usual minimum size which prevents poles from becoming too narrow.

It would be desirable to overcome or alleviate at least one of the above-described problems, or at least to provide a useful alternative.

### SUMMARY

There is a need in the art to provide a sensitive MR sensor that is scalable to include additional pole-pair magnets to increase the magnetic encoder resolution, and to provide a MR sensor from which to acquire absolute position.

The present disclosure provides a magnetic encoder for determining a position of a first object relative to a second object, comprising:
a first magnetic member comprising a multi-pole-pair magnet and having an axis;
a second magnetic member comprising at least one pole-pair magnet and having an axis parallel to the axis of the first magnetic member;
a sensor member comprising:
   a first sensor for measuring a change in magnetic field of the first magnetic member for deducing an unsigned absolute position of the first object relative to the second object; and
   a second sensor for measuring a change in magnetic field of the second magnetic member for deducing a sign for the unsigned absolute position,
wherein the first magnetic member and first sensor are coupled to respectively different ones of the first object and second object, and the second magnetic member and second sensor are coupled to respectively different ones of the first object and second object.

The first magnetic member and second magnetic member may be concentrically disposed. The first magnetic member may be annular and the second magnetic member may be concentrically within the first magnetic member. The second magnetic member may comprise a disc-shaped dipole magnet.

The first magnetic member may comprise an out-of-plane multi-pole-pair magnet.

The second magnetic member may comprise an in-plane magnet.

The first magnetic member may be a differential-track multi-pole-pair magnet, and the first sensor may sense a magnetic field of each track of the first magnetic member.

The first magnetic member and second magnetic member may each comprise a linear multi-pole-pair magnet. The multi-pole-pair magnet of the first magnetic member may comprise a first number of pole-pairs, and the multi-pole-pair magnet of the second magnetic member may comprise a second number of pole-pairs, the first number and second number being mutually indivisible over a predetermined length of the magnetic encoder.

The first sensor may comprise a plurality of sensor elements disposed in a line. The first magnetic member and second magnetic member may be concentrically disposed, and the line may extend radially. The first sensor may or may not be radially aligned with the second sensor—i.e. sensor element(s) of the second sensor may or may not lie along the same line as the sensor elements of the first sensor. The first sensor and second sensor may be angularly offset. The plurality of sensor elements of the first sensor may form a Wheatstone bridge. Where the first magnetic member is a differential-track (or multiple magnetic track) magnetic member, the sensor elements may form a Wheatstone bridge for each track—e.g. the first sensor may comprise eight sensor elements, four of which form the first Wheatstone bridge and the other four elements form the second Wheatstone bridge. One pair of opposite elements of the first Wheatstone bridge together with one pair of opposite elements of the second Wheatstone bridge locate on one track of a two track differential track magnet, and the other pair of elements of the first Wheatstone bridge together and the other pair of elements of the second Wheatstone bridge locate on the other track. Thus, the two Wheatstone bridges are mixed for each track of a differential-track magnet. The Wheatstone bridges may be inside a single sensor. For each Wheatstone bridge, the sensor elements may be identical with the pinned layers aligned in one direction. Where two Wheatstone bridges are in a sensor, the pinned layers of the four sensor elements forming one Wheatstone bridge may be aligned at 90 degrees to the pinned layer direction of the other four sensor elements forming the second Wheatstone bridge. The first magnetic member may comprise a differential-track multi-pole-pair magnet and the plurality of sensor elements may form:
two elements of first Wheatstone bridge together with two elements of second Wheatstone bridge for sensing variation of a magnetic field of a first track of the differential-track multi-pole-pair magnet; and
two elements of first Wheatstone bridge together with two elements of second Wheatstone bridge for sensing variation of a magnetic field of a second track of the differential-track multi-pole-pair magnet.

The second magnetic member may comprise a differential-track single-pole-pair magnet.

The second magnetic member may have in-plane magnetisation. The differential-track single-pole-pair magnet may comprise two or more concentric tracks.

The second sensor may comprise a plurality of sensor elements disposed in a line. The second magnetic member may be annular. The first magnetic member and second magnetic member may be concentrically disposed, and the line may extend radially

Some embodiments of absolute magnetic encoders taught herein comprise one in-plane dipole magnet and one out-of-plane multi-pole-pair magnet, may result in an absolute encoder with scalable resolution while minimising interference from Earth's magnetic field or other interference magnetic fields.

Some embodiments of encoders taught herein may further enhance rejection of common environmental magnetic noise and/or allow a hollow shaft encoder structure.

In some embodiments, sensor elements are radially aligned to read magnetic signals from the first track and second track of a differential-track to reject common magnetic interference and eliminate or reduce the constraints of physical pole-pair size. Moreover, one common sensor design can be used for various pole-pair magnet designs.

The first magnetic member may comprise an in-plane multi-pole-pair magnet.

The pinned layer of four sensor elements in one Wheatstone bridge may be in out-of-plane direction.

The first magnetic member may be a single-track multi-pole-pair magnet, and the first sensor may sense a magnetic field of the first magnetic member at an offside (e.g. radially outward of the first magnetic member) location.

Where two Wheatstone bridges are provided for a differential-track multi-pole-pair magnetic member, the pinned layer of the four sensor elements in both Wheatstone bridges may be in-plane. The pinned layer in one (e.g. the second) Wheatstone bridge may be at a 90-degree angle to the pinned layer in the other (e.g. the first) Wheatstone bridge.

When considering the generally circular configurations of encoder described herein, the term “in-plane” refers to the direction of magnetisation being within or parallel to the plane of the circle—i.e. perpendicular to the rotational axis of the rotating object. Similarly, “out-of-plane” refers to magnetisation being perpendicular to the plane of that circle—i.e. parallel to the rotational axis of the rotating object.

### BRIEF DESCRIPTION OF THE DRAWINGS

Embodiments of the present invention will now be described, by way of non-limiting example, by reference to the drawings, in which:

FIG. 1 is a schematic plan front view of a rotary encoder in accordance with present teachings;

FIG. 2a is the sine and cosine signals derived from relative rotation of the second sensor and second magnetic member of the rotary encoder of FIG. 1;

FIG. 2b is the angular position derived from the sine and cosine signals of FIG. 2a;

FIG. 3 is a flowchart for deriving absolute angle;

FIG. 4 is the absolute angular position derived from the angular position set out in FIG. 2b, using the flow set out in FIG. 3;

FIG. 5 is a multi-pole pair position signal;

FIG. 6 illustrates an experimental output of an encoder in accordance with present teachings, using an 8 pole-pair magnet, when compared with a conventional dipole magnet;

FIG. 7 illustrates a half-bridge TMR/GMR sensor configuration for a single-pole-pair magnet for encoder applications;

FIG. 8 illustrates a full Wheatstone-Bridge Schematic for (a) a sine circuit, and (b) a cosine circuit;

FIG. 9 illustrates a Hall sensor array configuration in multi-pole-pair encoder for external field cancellation;

FIG. 10 illustrates a configuration of differential-track magnet and TMR/GMR sensor to cancel external magnetic field.

FIG. 11 illustrates an embodiment of differential-track single-pole-pair magnet as the second magnetic member;

FIG. 12 illustrates an embodiment of differential-track multi-pole-pair magnet as the first magnetic member;

FIGS. 13 and 14 illustrate sensor structures for measuring angular position for differential-track magnetic members;

FIG. 15 is an embodiment of an encoder comprising a dipole magnet and differential-track multi-pole-pair magnet;

FIG. 16 is an embodiment of an encoder comprising a differential-track single pole-pair magnet and a differential-track multi-pole-pair magnet;

FIG. 17 is an embodiment of an encoder comprising two differential-track multi-pole-pair magnetic members, with one track having n pole-pairs and the other track having n+1 pole-pairs;

FIG. 18 illustrates a linear encoder comprising two differential-track multi-pole-pair magnetic members, one with n pole-pairs and the other with n+1 pole-pairs;

FIG. 19 illustrates the passage of a sensor arrangement according to FIG. 13 or FIG. 14, over a junction between neighbouring poles;

FIG. 20 illustrates the placement of various sensor configurations to sense perpendicular fields of a common multi-pole magnetic member;

FIG. 21 is a schematic illustration showing the magnetic fields and placement of sensors within those fields;

FIG. 22 shows the output of a first of the sensor configurations shown in FIG. 20;

FIG. 23 illustrates the placement of sensors substantially radially outward of a multi-pole magnetic member;

FIG. 24 is a schematic illustration showing the magnetic fields and placement of sensors within those fields;

FIG. 25 shows the combined output of a second of the sensor configurations shown in FIG. 20.

### DETAILED DESCRIPTION

The magnetic encoders described herein are for determining a position of a first object relative to a second object. Such encoders may be rotary encoders, linear encoders or other configurations of encoder that can learn from present teachings. For rotary encoders, for example, the first object may be a shaft and the second object may be a bushing for retaining that shaft. Linear encoders on the other hand may be used to measure, for example, relative sliding movement between two objects such as a telescoping arm of a pick-and-place machine or crane boom.

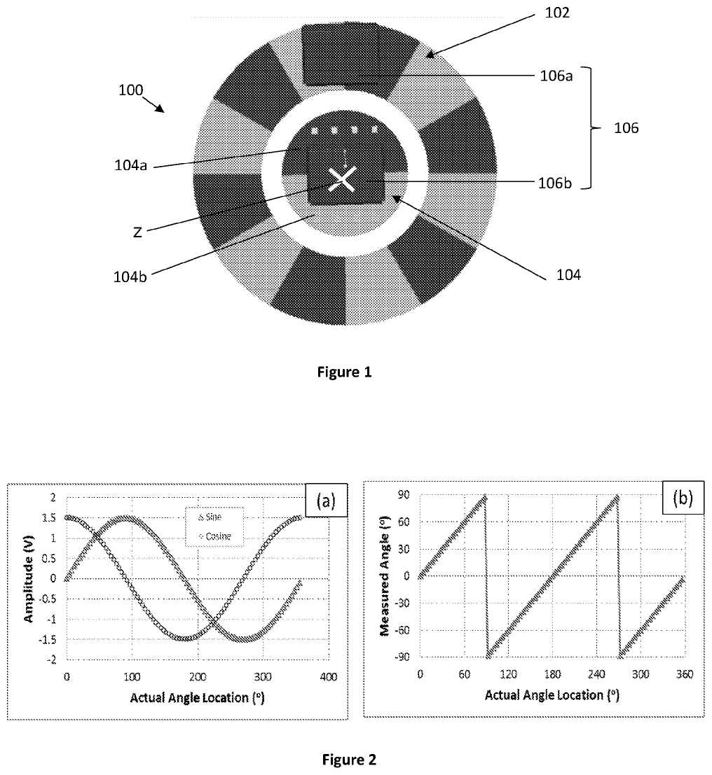

One such encoder 100, shown in FIG. 1, includes a first magnetic member 102, a second magnetic member 104 and a sensor member 106. In this embodiment, the encoder 100 is a rotary encoder.

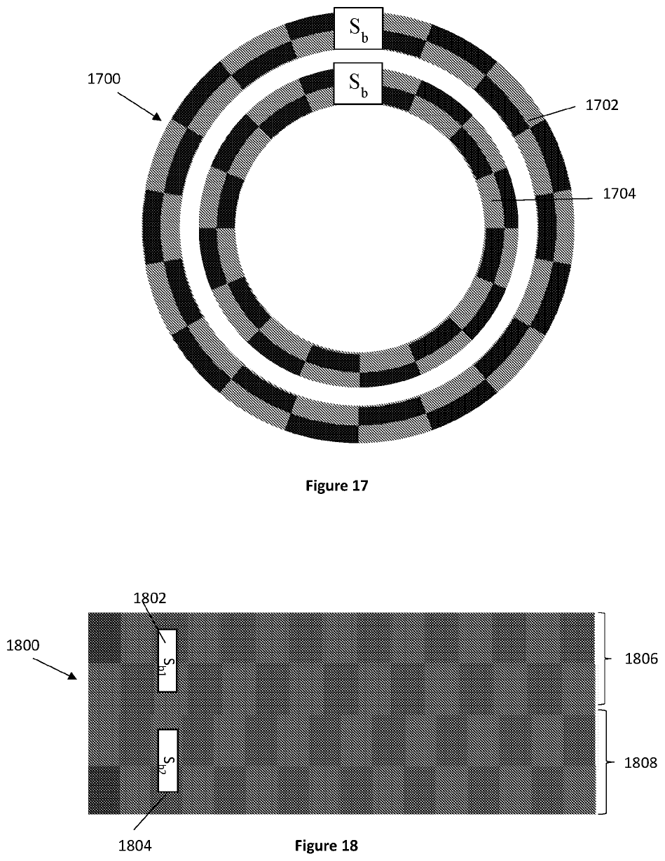

The first magnetic member 102 comprises a multi-pole-pair magnet that has an axis Z. Since the first magnetic member 102 is circular, for measuring angular rotation, the axis Z extends out of page. The second magnetic member 104 is a dipole magnet also having axis Z—the axes of members 102 and 104 are thus parallel. In line with other embodiments, such as that shown in FIG. 17, the second magnetic member may also comprise a multi-pole-pair magnet.

The first magnetic member 102 has out-of-plane magnetisation. Considering the plane of the encoder 100 is parallel to the circular face as shown—i.e. normal to axis of rotation Z—the first magnetic member 102 has thus been magnetised such that it produces a magnetic field extending generally out of the page and thus out of the plane of the encoder 100 and first magnetic member 102 itself. Thus, for a rotary encoder in accordance with present teachings, out-of-plane magnetisation is axial magnetisation.

Contrastingly, the second magnetic member 104, the dipole magnet, has in-plane magnetisation. The second magnetic member 104 has thus been magnetised such that it produces a magnetic field extending within the plane of the encoder 100. Thus, for a rotary encoder in accordance with present teachings, in-plane magnetisation is radial magnetisation.

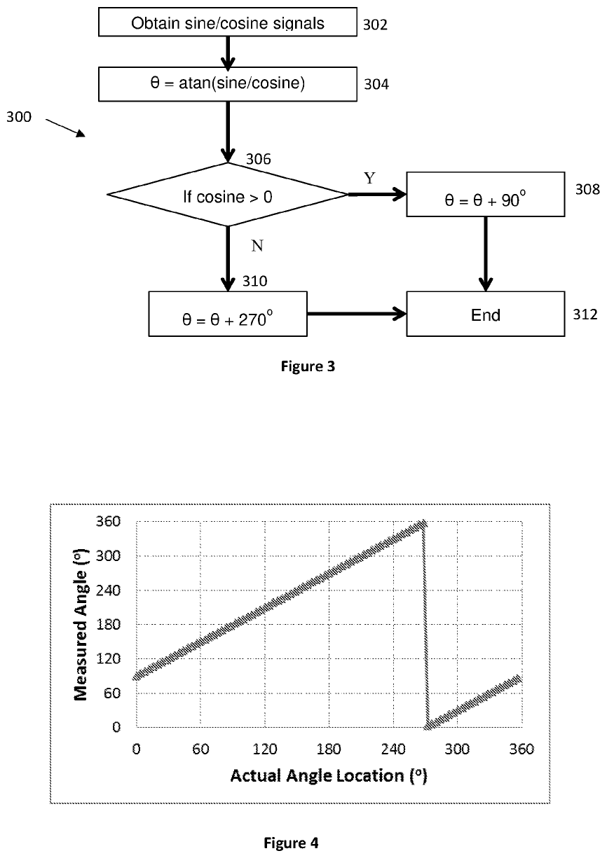

The sensor member 106 includes a second sensor 106b for measuring a change in magnetic field of the second magnetic member 104. The second sensor can be used, as described with reference to FIGS. 2 and 3, to deduce a signed absolute position of the second object relative to the first object. The sensor member 106 also include a first sensor 106a for measuring a change in magnetic field of the first magnetic member 102, to deduce a fine absolute position.

The first magnetic member 102 and first sensor 106a are coupled to respectively different ones of the first object and second object, and the second magnetic member 104 and second sensor 106b are coupled to respectively different ones of the first object and second object. Thus, measurements from the two sensor 106a, 106b can provide an absolute angular position of, for example, a shaft relative to a bushing or other fixed member.

Encoder 100 therefore provides one in-plane (radial magnetization) dipole magnet 104 and one out-of-plane (axial magnetization) multi-pole-pair magnet 102 that can enable fabrication of an absolute encoder with scalable resolution and minimised interference from Earth's magnetic field. While the multi-pole-pair magnet has been shown as being out-of-plane, in some embodiments it may instead have in-plane magnetic orientation.

Second sensor 106b has multiple sensor elements (i.e. components, of each sensor, that are affected by the change in magnetic field, to produce an output such as a voltage that is proportional to the magnetic field or change therein) to produce sine and cosine signals simultaneously from magnetic poles 104a, 104b, as discussed with reference to FIG. 2. Second sensor 106b may also calculate an angle of relative rotation between the first and second objects. Alternatively, the second sensor 106b may send the measurements to a processing unit (not shown) to determine the angle in a known manner.

Sensors 106a and 106b are magnetic sensor which may be Hall sensors, Anisotropic Magneto-Resistive (AMR), Giant Magneto-Resistive (GMR) or Tunnelling Magneto-Resistive (TMR) sensors. In the present disclosure, TMR sensors were implemented.

For a sensor positioned as shown in FIG. 1, the sensor elements within the sensor will be generally aligned perpendicularly to the out-of-plane magnetic field. Similarly, the sensor elements are parallel to the direction of magnetisation of in-plane magnetised poles.

A typical sine and cosine signal representing the amplitude or strength of the magnetic field produced by opposing poles 104a, 104b and thus from second sensor 106b during rotation of dipole magnet 104 relative to second sensor 106b is shown in FIG. 2a. The absolute angular position of dipole magnet 104 relative to second sensor 106b, and thus of, for example, a shaft relative to a bushing, can be derived from the arctangent of the instantaneous ratio of the sine and cosine signals. The resultant angle is in the range of −90° to +90° as shown in FIG. 2b.

A flowchart or algorithm 300 for converting the resultant angle into absolute position is shown in FIG. 3. After measuring the sine and cosine signals—step 302—the arctangent is calculated as set out above—step 304. If the cosine signal is positive—step 306—the absolute angle position is calculated as the arctangent (i.e. θ)+90°—step 308. The angular position is otherwise calculated as θ+270°—step 310. The process flow 300 then terminates—step 312.

FIG. 4 shows an example of a single, full revolution of the dipole magnet 104 with respect to sensor 106b, and thus of the output signal of the dipole magnet encoder (i.e. the dipole magnet 104, sensor 106b and processor (not shown), if applicable, for calculating absolute angular rotation).

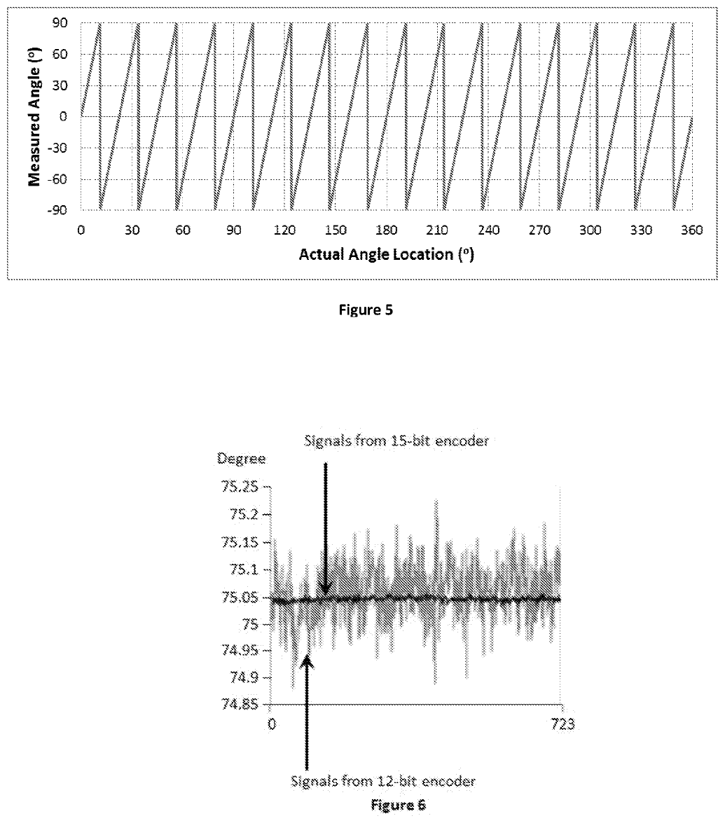

Similar to FIG. 2 for a dipole magnet, FIG. 5 shows an example of multiple pole-pair position signal (from −90° to 90°) over a full rotation of the first magnetic member 102 relative to first sensor 106a—i.e. a 360° rotation. The multi-pole pair magnet 102 can provide very accurate position sensing (whether resolution includes change in magnetic field, or simply leading and/or trailing switched edges between neighbouring poles having opposing signs—e.g. sine and cosine). However, that magnet 102 is an incremental encoder rather than an absolute encoder—measurements from magnet 102 cannot indicate absolute position by itself unless individual poles are differently magnetised, which becomes increasingly difficult with more poles and higher resolution.

The embodiment shown in FIG. 1 integrates a single pole-pair magnet 104 and multi-pole pair magnet 102 to form an absolute encoder. The angle of the single pole-pair magnet 104 provides the absolute coarse angle—this is equivalent to a close fit to actual position—and the multi-pole-pair magnet 102 provides fine resolution of the absolute position once both magnetic members 102, 104 are integrated into a single system to measure a common displacement or angular position.

In typical embodiments, sensors 106a, 106b will be capable of 12-bit interpolation resolution from single pole-pair signals. The single pole-pair interpolation resolution can be higher than 12-bit if the quality of the raw signal is good—i.e. higher resolution will result from higher quality raw signal—using high resolution analogue-to-digital conversion (ADC) and additional signal processing to meet the higher resolution requirements.

Table 1 shows the scaling effect of a multi-pole-pair magnet based on the assumption that 12-bit interpolation resolution is achievable—e.g. based on the raw signal quality. Table 1 shows that a 24-bit encoder can be achieved using multipole-pair member 102 with 12-bit resolution of the signal from sensor 106b.

TABLE 1
encoder resolution scalability relative to number of pole
pairs of magnetic member 102

| No. | Resolution | | |
|---|---|---|---|
| Pole-Pairs | Required | | |
| of member | of dipole | Resolution | |
| 102 | magnet signal | from Sb PP | Overall Resolution |
| 1 | — | 12-bit (4096) | 12-bit (4096) |
| 16 | 4-bit (16) | 12-bit (4096) | 16-bit (65536) |
| 64 | 6-bit (64) | 12-bit (4096) | 18-bit (262144) |
| 256 | 8-bit (256) | 12-bit (4096) | 20-bit (1048576) |
| 1024 | 10-bit (1024) | 12-bit (4096) | 22-bit (4194304) |
| 4096 | 12-bit (4096) | 12-bit (4096) | 24-bit (16777216) |

To test the effect of this scalability, an eight pole-pair proof of concept encoder prototype was fabricated. The encoder resolution gained an additional 3-bits from the dipole encoder alone. The result is shown in FIG. 6. This is encouraging as it aligns with the predicted improvement in resolution as set out in Table 1, namely the additive nature of the resolution of the signal from the dipole and multi-pole magnets.

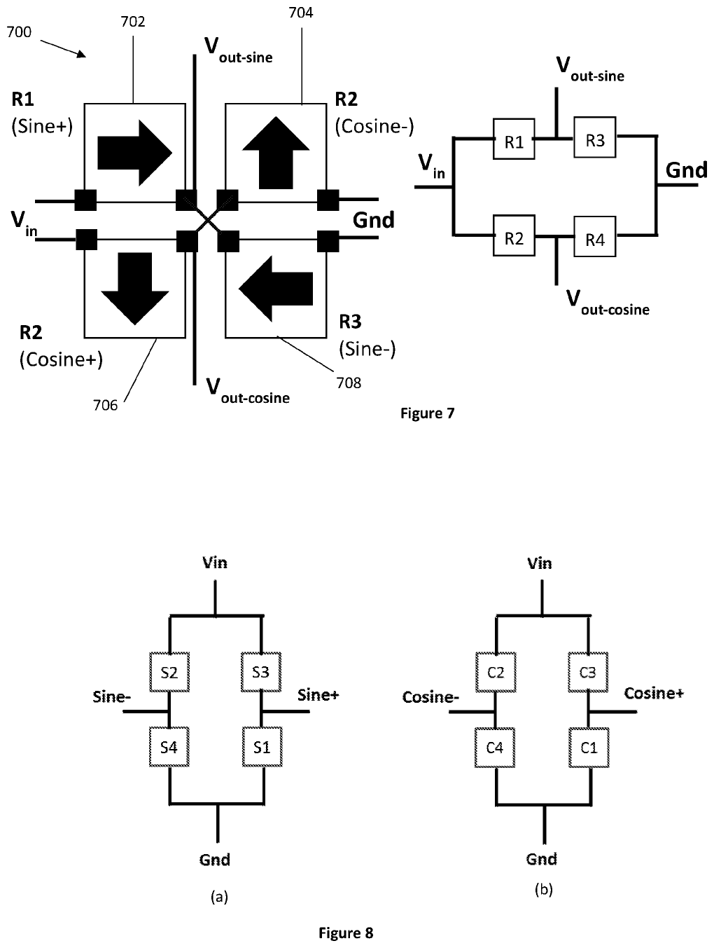

In the current state-of-art angle detection TMR/GMR sensor, sensors element have four different pinned layers to provide, respectively, the sine (+), sine (−), cosine (+) and cosine (−) signals. Such a sensor 700 is shown in FIG. 7, representing a simple half-bridge TMR/GMR sensor configuration. The spacing of the sensor elements 702, 704, 706 and 708 is, in practice, generally a square arrangement as shown.

Presently proposed is a full-bridge sensor configuration shown in FIG. 8. This will double the sensor sensitivity will concurrently rejecting common electronic noise. However, state-of-art sensors configuration are still subject to common magnetic field noise such as the Earth's magnetic field. In the sensor configuration shown in FIG. 8, the sine circuit (a) provides sensor elements S1, S3 for registering the sine(+) signal, and sensor elements S2, S4 for registering the sine(−) signal. Similarly sensor elements C1, C3 register the cosine(+) signal and sensor elements C2, C4 register the cosine (−) signal.

In contrast, the embodiment of FIG. 1 is designed to reduce external earth magnetic field interference in proportion to the number of pole-pairs of the multi-pole-pair magnet. For example, if the interference from the Earth's magnetic field gives an error of 0.1° for a single pole-pair magnet, a 64 pole-pair magnet used in the embodiment of FIG. 1 may reduce the error to 0.00156°. The scaling factor for the interference error is thus proportional to the number of poles in the multi-pole-pair magnet.

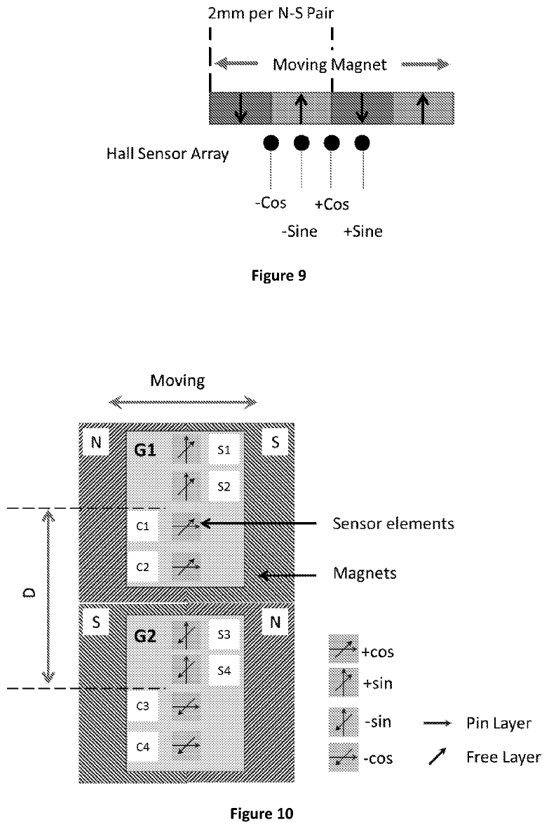

FIG. 9 illustrates the cancellation of external magnetic field interference on magnetic poles. Assuming the effect of external magnetic fields is generally uniformly applied across all poles being sensed, the noise applied to the positive signal (e.g. sine(+) and cosine (+)) will cancel the noise applied to the negative signal (e.g. sine(−) and cosine (−)) in the embodiment shown in FIG. 9.

Hall sensor arrays can be used for this purpose. A Hall sensor only measures the magnitude of the magnetic field without the direction information of magnetic field. To ensure appropriate cancellation of interference and the additive nature of the signals, thereby to maintain or improve raw signal quality and thus sensor resolution, each identical sensor element needs to be positioned in a precise location on the multi-pole-pair magnet to create sine and cosine signals for angle derivation. Any variation of sensor position with respect to sensor pole-pairs will induce angle error. Implementation of Hall sensor configurations in high resolution encoders therefore requires stringent tolerance of Hall sensor positions within a sensor package. This also requires stringent tolerance of the width of each magnet pole-pair, as well as of the location of the sensor, and thus sensor elements, relative to the magnetic member. Hall sensors therefore experience a scalability issue since the relative positions of the sensor elements in a square configuration, the resulting minimum widths of Hall sensor element arrangements, becomes increasingly difficult to ensure as resolution increases. Since Hall sensors need to be of a specific size to maintain the signal quality, a 0.5 mm sensor distance or width is the approximate limit for Hall sensor arrays.

FIG. 10 shows an embodiment of a sensor member, for an encoder using a differential-track magnetic member, that solves the external field interference problem while addressing limitations of Hall sensor tolerance and size. In the configuration shown in FIG. 10, which may be a TMR or GMR sensor, cancellation is achieved using only two magnetisation directions in the pinned layer, when compared with four magnetisation directions in prior art configurations. Thus, each sensor element (e.g. the pinned layer of the sensor element) is magnetised in one of two predetermined directions, depending on the orientation of the sensor on the magnetic member, or of the magnetic field being sensed.

Sensor member 1000, comprises two sensors G1 and G2. Sensor G1 comprises sensor elements S1, S2, C1 and C2 while sensor G2 comprises sensor elements S3, S4, C3 and C4. The first sensor, presently embodied by sensor 1000, may thus comprise a plurality of sensor elements C1, C2, C3, C4, S1, S2, S3 and S4 disposed in a line. Since the encoder is a rotary encoder, having an axis of rotation Z (see FIG. 1) the first magnetic member and second magnetic member are concentrically disposed, and the line of sensor elements extends radially.

In this embodiment, sensor elements S1, S2, S3 and S4 may form a first Wheatstone bridge as shown in FIG. 8, and sensor elements C1, C2, C3 and C4 may form a second Wheatstone bridge as shown in FIG. 8. An opposite pair of sensor elements (S1, S2) of the first Wheatstone bridge and an opposite pair of sensor elements (C1, C2) of the second Wheatstone bridge are arranged to sense variation of a magnetic field of a first track of a differential-track multi-pole-pair magnet as described herein. Similarly, another opposite pair of sensor elements (S3, S4) of the first Wheatstone bridge and another opposite pair of sensor elements (C3, C4) of the second Wheatstone bridge are arranged to sense variation of a magnetic field of a second track of the differential-track multi-pole-pair magnet.

The pinned layer configurations of G1 are identical to G2, and the sensor elements in G1 and G2 are aligned radially as mentioned above. This design may eliminate phase error between sine and cosine signals which is a common error inherent in conventional sensor structures, since all sensor elements approach pole boundaries at the same time. This error increases as pole widths decrease and the effect of manufacturing tolerances are thereby magnified.

In a differential track arrangement, G1 (in sensor 1106) reads the signal from first track 1102 of differential-track magnet 1100 (see FIG. 12) and G2 (in sensor 1106) reads the signal from second track 1104 of the differential-track magnet 1100. Moreover, G1 and G2 can be package into a single chip.

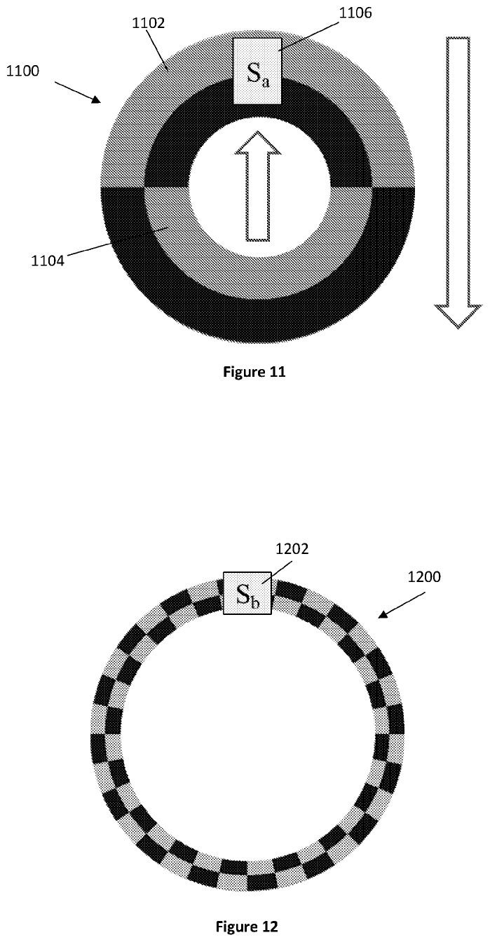

The distance, D between G1 and G2 is dependent on track spacing between the first track 1102 and the second track 1104 of differential-track magnetic member 1100. The typical distance is about 1.5 mm to 2 mm. The differential-track magnet presents opposite magnetic fields to G1 and G2 to generate differential signal for sine+/sine− and cosine+/cosine− when using a full-Wheatstone bridge arrangement as shown in FIG. 8. The differential signal generated by the opposing poles of the differential-track magnet 1100 allows cancellation of common magnetic field interference. Moreover, the novel sensor configuration substantially eliminates the constraints place on physical pole-pair size or width. This is because all sensor elements of G1 and G2 transition between circumferentially neighbouring poles at the same time. Therefore, there is no need for opposite sensors to be spaced at the same width as a pole as shown in the example of FIGS. 7 and 8. In addition, one common sensor design can be used for different pole-pair magnet designs—e.g. for the single pole-pair magnetic member 1604 and multi-pole-pair magnetic member 1602. The sensor arrangement thus described can therefore be used in a differential-track embodiment in a single magnet encoder structure for both of absolute and incremental encoding.

Where FIG. 11 illustrates a differential-track single pole-pair magnetic member 1100 with in-plane (radial) magnetic field, FIG. 12 illustrates a differential-track multiple-pole-pair magnetic member 1200 with out-of-plane (axial) magnetic field. The out-of-plane magnetization is not favourable for magnet pattern in FIG. 11 since the spacing between sensor and magnet has to be large to create sinusoidal signals with minimum higher order harmonic signals. Contrastingly, in-plane magnetization can be used in the magnet pattern in FIG. 12.

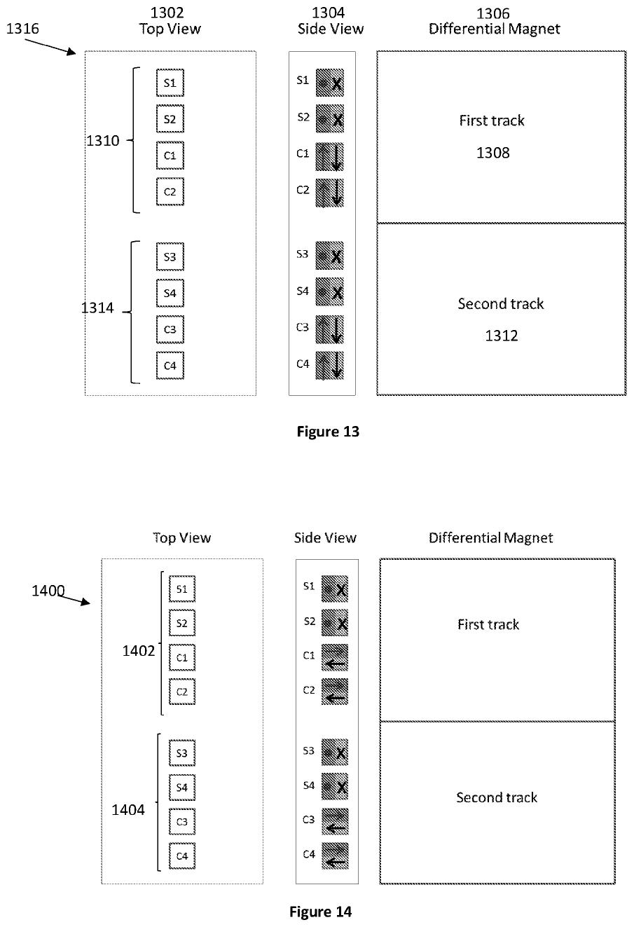

Sₐ (1106 in FIG. 11) and S_{b} (1202 in FIG. 12) are TMR/GMR sensors corresponding respectively to the configurations shown in FIGS. 13 and 14. Sₐ (1316) in FIG. 13 provides a top view 1302 of the sensor elements showing radial alignment when placed on a rotary encoder magnetic member, over differential-track 1306, which provides a first track 1308 for sensor element group 1310, and a second track 1312 for sensor element group 1314. As seen from side view 1304, the sensor 1316 senses magnetic signals in X and Y directions. These directions align with a radial (in-plane) magnetisation direction of the poles. S_{b} (1400) in FIG. 14 is similarly constructed, except due to out-of-plane magnetisation (i.e. axial with respect to axis Z of FIG. 1) the sensor elements groups 1402, 1404 are configured to sense the signals in X and Z directions.

FIG. 19 illustrates alignment of the sensor elements of a sensor 1900 with a junction between opposing magnetic poles as the tracks 1902, 1904 and sensor 1900 move relative to each other. It is clear that a much narrower pole-pair arrangement can be used when compared with conventional technologies, on the basis that the sensor elements are disposed in a narrow, radially extending (or transversely relative to the longitudinal length direction for a linear encoder) line, and placement tolerance is generally reduced to positioning radially/transversely and with the gap between sensor elements C2 and S3 aligning with the gap between radially/transversely disposed poles/tracks.

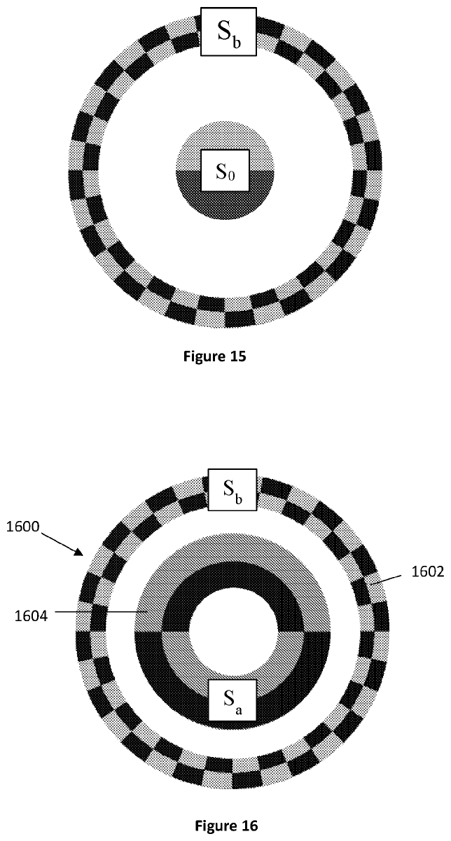

A further embodiment 1500 employing the concept of a differential-track multi-pole pair magnet is shown in FIG. 15. S0 is equivalent to sensor 106b of FIG. 1 in the configuration of FIG. 7, and Sb is equivalent to sensor 1400 of FIG. 14. Both sensors S0, Sb are TMR/GMR sensors for detecting single pole-pair and multiple pole pair magnetic tracks, respectively. The differential-track may be axially magnetised and the central dipole may be radially magnetised.

FIG. 16 shows yet another embodiment 1600 of an encoder employing a differential-track arrangement, in which a differential-track multi-pole-pair magnetic member 1602 (see also FIG. 12) and a differential-track single-pole-pair magnetic member 1604 (see also FIG. 11) are concentrically arranged. The multi-pole-pair member 1602 may be axially magnetised and the single-pole-pair member 1604 may be radially magnetised, and the directionality of sensor elements as, for example, illustrated in FIGS. 13 and 14 may be selected to match the magnetic field direction of the poles.

The encoder 1700 of FIG. 17 employs two separate, concentrically disposed differential-track multi-pole-pair magnetic members 1702, 1704. The outer differential-track magnetic member 1702 has (n+1) pole-pairs while inner track 1704 has n pole-pairs.

The present concepts are capable of application outside the fields of rotary encoding shown in the embodiments of FIGS. 1, 11, 12 and 15 to 17. For example, similar differential-track multi-pole-pair magnetic members can be extended to a linear encoder 1800 as shown in FIG. 18. In this embodiment, a first sensor 1802 measures a magnetic field of a first differential-track 1806 and a second sensor 1804 measures a magnetic field of a second differential-track 1808. Both sensors 1802 and 1804 have the same structure of S_{b} (1400 in FIG. 14). To provide absolute linear position or displacement from a starting point (e.g. the leftmost position of the tracks 1806, 1808 as shown) the lower differential-track 1808 contains one more pole-pair than differential-track 1806 over a predetermined distance. Thus, both the first magnetic member 1806 and the second magnetic member 1808 comprise a linear multi-pole-pair magnetic member or differential-track, the multi-pole-pair magnet of the first magnetic member comprises a first number of pole-pairs, and the multi-pole-pair magnet of the second magnetic member comprises a second number of pole-pairs, and the first number and second number are mutually indivisible over a predetermined length of the magnetic encoder. By making the numbers of pole-pairs indivisible there is, in effect, a unique pole measurement arrangement for each position of the aligned sensors 1802, 1804 along the differential-track members 1806, 1808. This makes an absolute linear encoder rather than an incremental linear encoder.

In addition to the foregoing configurations, some embodiments enable use of the present teachings with hollow shafts or central shafts—see, e.g., FIGS. 11, 16 and 17. In FIGS. 11 and 16 a single-pole-pair differential-track is used as a central magnetic member in a concentric arrangement of magnetic members—that arrangement may include greater numbers of concentrically disposed magnetic members as needed for a desired resolution or application. In FIG. 17, a multi-pole-pair differential-track is used as the central magnetic member for receipt of, or attachment to, a hollow shaft. The pole-pair arrangements in each case facilitate cancellation of external interference on the magnetic fields of the poles being sensed. The various magnetic members may each be magnetised in-plane, or axially, as required for a particular sensor element configuration or application.

Further to the foregoing, sensor placement relative to a magnetic field is important for accuracy and sensitivity. Using a TMR sensor as an example, a TMR sensor has two key functional layers, being a magnetic pinned layer and free layer, between which is an insulator through which, according to quantum mechanics, electrons may pass. The pinned layer has fixed magnetic direction regardless of the direction of an applied external magnetic field. Contrastingly, the direction of magnetism of the free layer of a TMR sensor follows the direction of magnetism of the external magnetic field. Moreover, the resistance of a TMR sensor depends on the angle between pinned layer magnetization direction and free layer magnetization direction. When the magnetizations of pinned layer and free layer are in parallel, the TMR sensor has its lowest resistance. When the magnetizations of pinned layer and free layer are anti-parallel, the TMR sensor has its highest resistance.

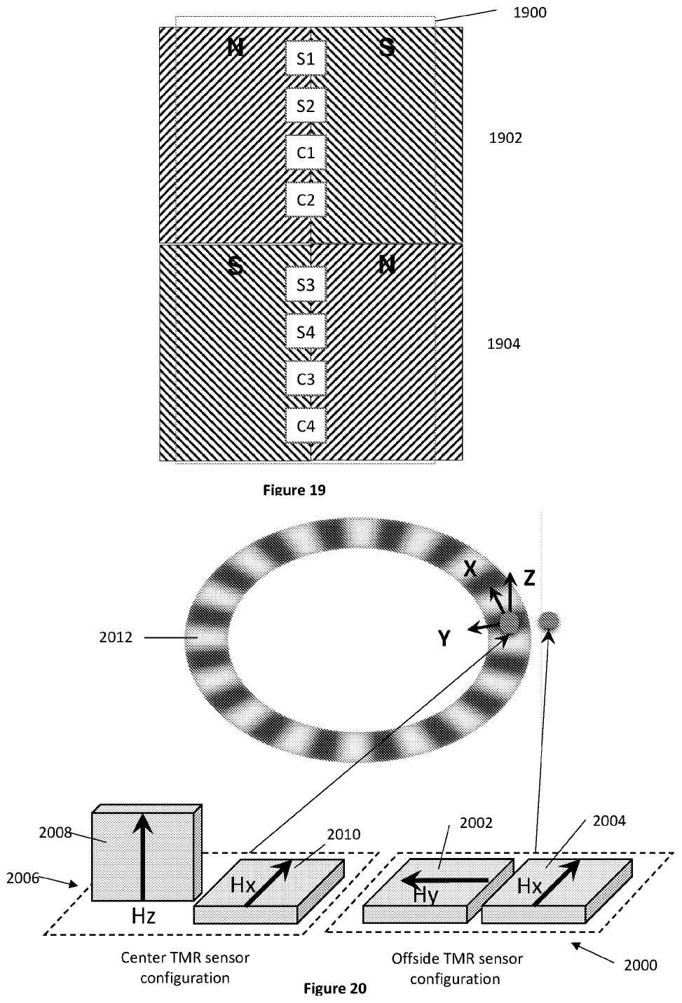

When a TMR sensor is fabricated on a wafer, both the pinned layer and the free layer are in-plane (see, e.g., sensors 2002, 2004 of sensor 2000 of FIG. 20). In the packaging, TMR sensor can be placed in both in-plane or out-of-plane (see, e.g., sensors 2010, 2008 of sensor 2006) of IC chip.

For a multi-pole-pair ring magnetic member 2012 with out-of-plane magnetization as shown in FIG. 20, when a TMR sensor is located at the center of ring magnet, there are only 2 magnetic fields being picked up by the sensor. These magnetic fields are along the X-axis (tangential to the circumference of the magnetic member 2012) and Z-axis (the axial direction). The magnetic field along the radial, Y-axis is zero. The resultant output of magnetic fields change measurement as track 2012 and sensor 2006 move relative to each other is shown in FIG. 22.

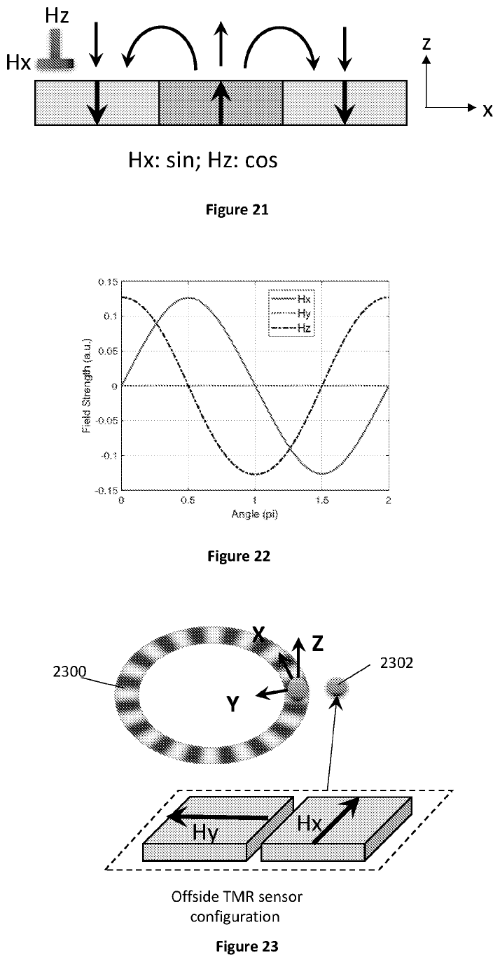

FIG. 21 illustrates the field distributions along the X- and Z-axes (Hx being the magnetic field along the X-axis and Hz being the magnetic field along the Z-axis) at the centre of track 2012 of FIG. 20. To pick up magnetic fields along the X-axis and Z-axis, the sensor requires two sets of TMR sensor elements (i.e. two sensors as shown in FIG. 20), one set of TMR sensor elements should be in-plane with the pinned layer magnetisation direction being along the X-axis and another at out-of-plane set of TMR sensor elements with the pinned layer magnetisation direction being along the Z-axis. This configuration of TMR sensors—configuration 2006 of FIG. 20—is able to pick up strong fringing fields from magnetic track 2012.

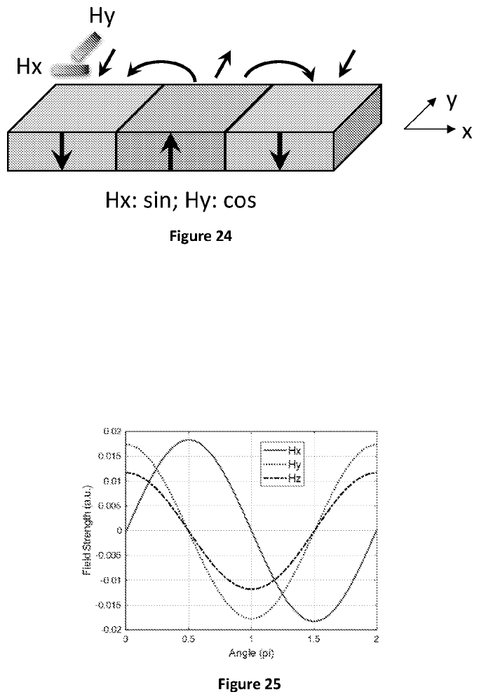

However, due to fabrication difficulties and production volume limitations, most available two-axis TMR sensors are in-plane per arrangement 2000 of FIG. 20. When the TMR sensors of a two-axis TMR sensor are in-plane, that two-sensor arrangement may be placed at position 2302 outside the circumference of the ring magnet 2300 as shown in FIG. 23. The 2-axis in-plane TMR sensors are then positioned to pick up fringing magnetic fields along X-axis and Y-axis, the magnetic field distribution outside the ring magnet 2300 being illustrated in FIG. 24.

At the edge of ring magnet 2300, there are actually magnetic fields in all three axes. However, the two-sensor, therefore two-axis, in-plane TMR sensors detect Hx and Hy (magnetic field along the Y-axis) as sine and cosine signals for angle calculations. The magnetic field measurements along all three axes are illustrated in FIG. 25 though, for two-sensor configurations such as 2000 and 2006 of FIG. 20, only two of the three perpendicularly axial magnetic fields will be measured.

Thus, there is also disclosed an encoder comprising a circular multi-pole magnetic member—e.g. member 2012 of FIG. 20—and a sensor member, the sensor member comprising at least one sensor, the sensor member being position radially outside a circumference of the magnetic member, to align a direction of magnetisation of one of said sensors with a radial magnetic field of the magnetic member.

There are some potential drawbacks to the configuration shown in FIG. 23 including that the strength of fringing magnetic fields is usually much weaker than in the centre of the track, and the location tolerance becomes tight in order to achieve strong enough magnetic fields.

It has been empirically demonstrated that the arrangement shown in FIG. 23 works using a single track ring magnet without differential tracks. The interference of external magnetic field is at ˜0.1° with ˜10 Oe disturbance field. Using a mild steel casing to provide magnetic shielding in practical applications can reduce magnetic field inference by more than 5×.

It will be appreciated that many further modifications and permutations of various aspects of the described embodiments are possible. Accordingly, the described aspects are intended to embrace all such alterations, modifications, and variations that fall within the spirit and scope of the appended claims.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

1. A magnetic encoder for determining a position of a first object relative to a second object, comprising:
a first magnetic member comprising a multi-pole-pair magnet and having an axis;
a second magnetic member comprising at least one pole-pair magnet and having an axis parallel to the axis of the first magnetic member;
a sensor member comprising:
a first sensor for measuring a change in magnetic field of the first magnetic member for deducing an unsigned absolute position of the first object relative to the second object; and
a second sensor for measuring a change in magnetic field of the second magnetic member for deducing a sign for the unsigned absolute position,
wherein the first magnetic member and first sensor are coupled to respectively different ones of the first object and second object, and the second magnetic member and second sensor are coupled to respectively different ones of the first object and second object;
wherein the first magnetic member and second magnetic member are concentrically disposed, and the first sensor comprises a plurality of sensor elements disposed in a radially extending line.

2. The magnetic encoder according to claim 1, wherein the first magnetic member and second magnetic member are concentrically disposed.

3. The magnetic encoder according to claim 2, wherein the first magnetic member is annular and the second magnetic member is concentrically within the first magnetic member.

4. The magnetic encoder according to claim 3, wherein the second magnetic member comprises one of a disc-shaped dipole magnet and an annular dipole magnet.

5. The magnetic encoder according to claim 1, wherein the first magnetic member comprises an out-of-plane multi-pole-pair magnet.

6. The magnetic encoder according to claim 1, wherein the second magnetic member comprises an in-plane magnet.

7. The magnetic encoder according to claim 1, wherein the first magnetic member is a differential-track multi-pole-pair magnet, and the first sensor senses a magnetic field of each track of the first magnetic member.

8. The magnetic encoder according to claim 1, wherein the first magnetic member and second magnetic member each comprise a linear multi-pole-pair magnet.

9. The magnetic encoder according to claim 8, wherein the multi-pole-pair magnet of the first magnetic member comprises a first number of pole-pairs, and the multi-pole-pair magnet of the second magnetic member comprises a second number of pole-pairs, the first number and second number being mutually indivisible over a predetermined length of the magnetic encoder.

10. (canceled)

11. The magnetic encoder according to claim 1, wherein the first sensor comprises a plurality of sensor elements forming at least one Wheatstone bridge.

12. The magnetic encoder according to claim 11, wherein the first Wheatstone bridge and the second Wheatstone bridge each comprise four sensor elements.

13. The magnetic encoder according to claim 12, wherein the first magnetic member comprises a differential-track multi-pole-pair magnet and the plurality of sensor elements form a first Wheatstone bridge and a second Wheatstone bridge, wherein:
an opposite pair of the sensor elements in the first Wheatstone bridge and an opposite pair of the sensor elements in the second Wheatstone bridge sense variation of a magnetic field of a first track of the differential-track multi-pole-pair magnet; and
another opposite pair of the sensor elements in the first Wheatstone bridge and another opposite pair of the sensor elements in the second Wheatstone bridge sense variation of a magnetic field of a second track of the differential-track multi-pole-pair magnet.

14. The magnetic encoder according to claim 1, wherein the second magnetic member comprises a differential-track single-pole-pair magnet.

15. The magnetic encoder according to claim 14, wherein the second magnetic member has in-plane magnetisation.

16. The magnetic encoder according to claim 14, wherein the differential-track single-pole-pair magnet comprises two or more concentric tracks.

17. The magnetic encoder according to claim 1, wherein the second sensor comprises a plurality of sensor elements disposed in a line.

18. The magnetic encoder according to claim 17, wherein the second magnetic member is annular.

19. The magnetic encoder according to claim 18, wherein the first magnetic member and second magnetic member are concentrically disposed, and the line extends radially.

20. The magnetic encoder according to claim 1, wherein a pinned layer of each sensor element is magnetised in one of two predetermined directions.
